(19) United States
(12) Patent Application Publication
(10) Pub. No.: US 2008/0149547 A1
(43) Pub. Date: Jun. 26, 2008

(54) Fixing System for at Least One Fluidic Component of a Chromatography Device

(76) Inventor: Richard Schloderer, Munich (DE)

Correspondence Address: THE CULBERTSON GROUP, P.C., 1114 LOST CREEK BLVD., SUITE 420, AUSTIN, TX, 78746, US

(21) Appl. No.: 11/816,958

(22) PCT Filed: Feb. 17, 2006
(86) PCT No.: PCT/DE06/00295

§ 371 Date: Aug. 23, 2007

(30) Foreign Application Priority Data
Feb. 23, 2005 (DE) 10 2005 008 620.9

(51) Int. Cl. B01D 15/08

(52) U.S. Cl. 210/198.2

(57) ABSTRACT

The invention relates to a fixing system for at least one fluidic component (4) of a chromatography device, particularly for fastening the at least one fluidic component (4) in a column oven, where at least one clasp (2) is provided, on which at least one fixing element (3) can be fixed in a detachable way in a desired position within a fixing area (2e) of the clasp (2) by friction or positive locking, where the at least one clasp (2) is fixed by means of one or more carrier elements (1) in a predetermined position, and where the at least one fixing element (3) is configured for receiving and fastening the at least one fluidic component (4). In addition, the invention relates to a fixing element for such a fixing system, in which a first part (31) of the fixing element (3) is connected to a second part (33) of the fixing element (3) in such a way that the fluidic component (4), which is to be held and fixed, can be fixed between two clamping areas of the first part (31) and the second part (33) by frictional locking or positive locking.

The invention relates to a fixing system for at least one fluidic component of a chromatography device, particularly for fastening the at least one fluidic component in a column oven having the characteristics of the preamble of claim 1, as well as a fixing element for such a fixing system having the characteristics of the preamble of claim 8.

In high performance liquid chromatography (HPLC), substances are separated in a so-called separation column. Because this process is highly temperature-dependent, it is necessary, as a rule, to maintain the temperature of the column. For this purpose, a container with temperature maintenance, the so-called column oven, is used. By means of it, the column temperature that is the most advantageous for a given separation process can be simultaneously set.

To carry out more elaborate separation processes, other fluidic components besides the separation column are required, particularly so-called preliminary columns or trapping columns. Using them, it is possible, for example, to concentrate substances, and undesired substances can be kept away from the separation column; furthermore, multidimensional separations can be carried out, which allow the analysis of complex substance mixtures. Different HPLC applications exist, which differ in the fluidic structure and the number of required components.

Because the processes that are active in the additional components are also temperature-dependent, it is necessary, as a rule, to accommodate the additional fluidic components in the column oven as well.

The separation column and the additional fluidic components, such as preliminary and trap columns, are referred to in the remainder of the text collectively as “columns.”

Appropriate fixing clasps for the columns are provided in the known fixing systems for fluidic components in the column oven, to achieve a clean structure and reproducible conditions. One difficulty here is that the columns may differ considerably with regard to their length and also their diameter, and, in addition, the multitude of conceivable applications also requires different arrangements of the components and the connection lines.

In known systems, this problem is solved by providing the possibility of rigidly screwing the fixing clasps in different positions. Different variants of the clasps or intermediate pieces are used for different column diameters.

The disadvantage here is that only a few, predetermined positions are available for the fixing clasps. As a result, there are no fixing possibilities for certain positions required to carry out some applications that were originally not planned. The connection lines leading from, to, or between the individual fluidic components can frequently not be fixed at all. In addition, altering for another application is expensive, because, besides the fluidic components, the fixing clasps also have to be altered.

Therefore, the invention is based on the problem of providing a fixing system for at least one fluidic component of a chromatography device, which can be adapted simply and rapidly to different requirements, and which allows the fixing of the fluidic components in nearly any position. Moreover, the invention is based on the problem of providing a fixing element for such a system by means of which the fluidic component can be fixed simply and rapidly.

This problem is solved by the combinations of characteristics of claims 1 and 8.

The invention is based on the realization that by using at least one clasp which is fixed to a carrier element, and to which at least one fixing element can be fixed in a detachable manner in a desired position within the fixing area of the clasp by friction locking or positive locking, a fixing system is produced with which the position of a fluidic component fixed with a fixing element can be selected freely, or at least nearly freely, within the fixing area of the clasp. Because fluidic components, such as columns and similar devices, usually have to be fixed horizontally, it is possible to provide vertical clasps, and to configure the fixing elements in such a way that the fluidic elements are held and fixed substantially perpendicularly to the pattern of the fixing areas.

The clasps can be fixed by means of one or more carrier elements in a predetermined position, where here the carrier element(s) can also present an area within which the clasps can be held in freely, or at least nearly freely, selectable positions, or at least in a multitude of different positions. As a result, the fluidic elements can be fixed in a partial area of a plane, freely, or nearly freely, but in any case in a multitude of different positions, without the need for the time-consuming relocation of fixing clasps. Different positions of the fluidic components in the third dimension can be achieved by using different clasps, whose fixation areas present different separations with respect to the carrier element(s). Instead, it is naturally also possible to use fixing elements of different lengths, which allow the fixation of the fluidic components at different separations from the fixing area of the clasps in question.

According to one embodiment of the invention, the at least one clasp can be fixed with its end areas to one carrier element, where the two carrier elements run preferably substantially parallel.

The at least one clasp can here be fixed with one end area in a multitude of predetermined positions to the carrier element in question, preferably by detachable, positive locking.

According to an embodiment of the invention, the end areas of the clasps can be held in corresponding bores of, in each case, one carrier element, where the clasps are preferably designed to be elastic and bendable such that they can be detached by bending from their fixed position. Such clasps can be manufactured in a very simple manner, for example, by bending a corresponding wire.

Different positions of the fixing elements on the clasps can be achieved by allowing the possibility of shifting the fixing elements within the fixing area of the clasps against the fastening force of frictional locking or of a notched positive locking.

A fixing element for such a fixing system can be configured in such a way that a first part is connected to a second part of the fixing system in such a way that the fluidic components to be held and fixed can be fixed between two clamping areas of the first part and the second part by frictional locking or positive locking. The two parts can here be completely detachable from each other, or they can present a resetting area that is sufficiently large so that the fluidic component can be used in a sufficiently widely opened position and clamped by axially sliding the two parts together.

The fixing element is preferably configured so that at least the usual fluidic components, such as HPLC columns having a diameter up to 8 mm, can be fixed.

Naturally, the first or second part of the fixing element can present engagement or fastening means for the detachable connection with the fixing area of a clasp. The fixing means are preferably designed so that a simple attachment of a clasp is possible without any installation tools.

According to an embodiment of the invention, the engagement and fastening means can present two arms, which can be brought in engagement with the fixing area of the clasp by a turning motion of preferably 90 degrees.

The two arms can respectively extend, starting from facing areas of the first part or the second part, toward each other and parallel to each other, and can enclose between them a separation which is such that, in a radial reception position, it is possible to receive the fixing area of the clasp between the arms and to subsequently bring the arms into engagement with the fixing area of the clasp by turning the first part or the second part of the fixing element by a predetermined angle about its longitudinal axis.

The first part of the fixing element according to the invention can present a U-shaped connection area for the detachable connection to the second part. The second part of the fixing element can comprise a central area, which is connected by one or more bridges with a ring that surrounds the central area, where the ring is designed to be elastically deformable at least in the radial direction in such a way that in the deformed state, the connection between the first part and the second part is detachable.

In the first and second parts of a fixing element that is configured in this way, in the connected state of the first part and the second part, the arms of the U-shaped connection area of the first part engage in the annular space between the central area and the ring of the second part, wherein the connection of the first part and the second part is achieved by friction locking or positive locking, particularly by a positive locking achieved by notched means, between the internal wall of the ring of the second part and the external walls of the arm of the U-shaped connection area of the first part.

For this purpose, in the connection areas of the external walls of the arms of the U-shaped connection area of the first part, first notched means can be provided, which work in cooperation with the second notched means, which are provided in engagement areas in the internal wall of the ring of the second part, for the notching connection of the first part and the second part.

The two parts of a fixing element that is designed in this way can be assembled without any tool, and they can be shifted toward each other until a fluidic component placed into the U-shaped area of the first part is sufficiently clamped and thus fixed. The fluidic component is here fixed by clamping, preferably in an elastic springy manner, between the base of the U-shaped connection area of the first part and the central area of the second part, if the first part is brought in sufficiently tight engagement with the second part in the axial direction.

To prevent any damage to the fluidic components, it is possible to provide a flexible, deformable push pad on at least one of the surfaces of the first or second part, which effect the clamping of the fluidic components.

The invention is explained in greater detail below with reference to an embodiment example represented in the drawing. In the drawing:

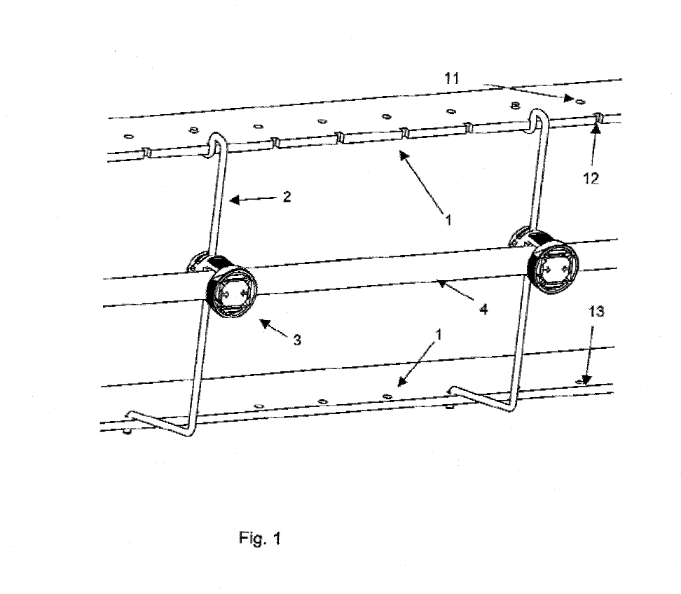

FIG. 1 shows a perspective view of an embodiment of a fixing system according to the invention;

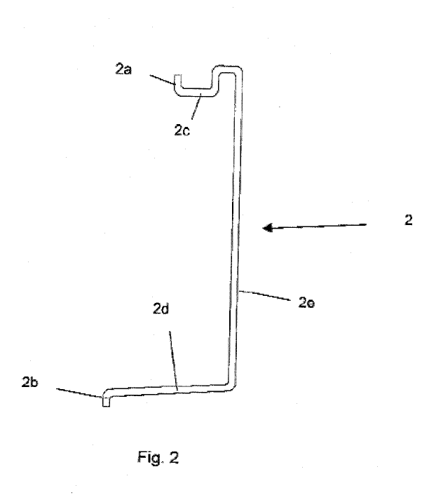

FIG. 2 shows a clasp of the system in FIG. 1 in an enlarged side view;

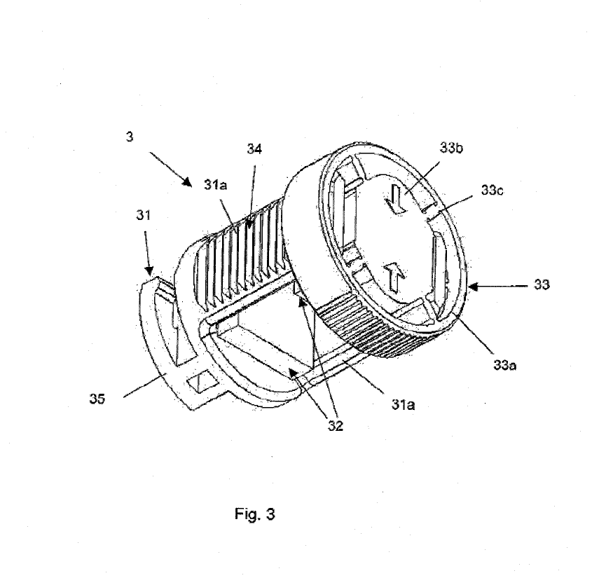

FIG. 3 shows a perspective representation of the fixing element in FIG. 1, and

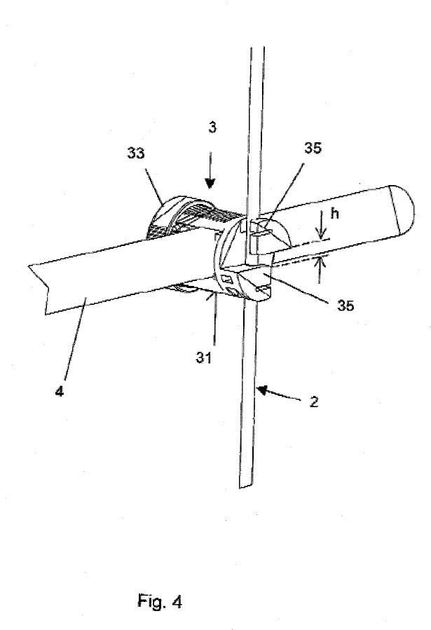

FIG. 4 shows, in sections, a perspective back view of the system in FIG. 1 with the representation of a fixing element attached to a clasp, with the fluidic component contained therein.

The fixing system—represented in FIG. 1—for fluidic components of a chromatography device can be used particularly for fastening the fluidic components in a column oven. Because the fluidic components must usually be kept horizontal, the fixing system shown in FIG. 1 is oriented accordingly. However, this should not be interpreted as a restriction.

The fixation system comprises carrier elements 1, which can also be connected in a not represented manner to a carrier frame. Each defined fixing position made possible by the carrier elements 1 and the fixing frame, respectively, is determined by an upper hole 11 in the upper carrier element, through a groove 12 in the lateral front side of the upper carrier element 1, as well as by a lower hole 13.

In the desired fixing positions, the clasps 2 are suspended in the carrier frames and the carrier elements, respectively. As shown enlarged in FIG. 2, the clasps 2 are provided for this purpose with appropriately shaped end areas, where the ends 2a, 2b—which run in the vertical direction—of the clasps respectively engage into the appropriate upper hole and lower hole 11, 13 in the upper and lower carrier element 1. The clasps 2 can consist, for example, of a springy wire or plastic.

Each clasp 2 can be supported by the selection of an appropriate geometry and preliminary tension, if necessary with horizontally oriented areas 2c, 2d, on the facing sides of the carrier elements that are designed as rails, to prevent vertical movement or vertical play of the clasps 2. However, this is not absolutely required if the force of gravity is sufficient to ensure a sufficiently stable vertical position of the clasps 2.

As a result of their spring action and the chosen shape, each clasp 2 can be inserted easily in the holes 11 and 13 of the carrier elements 1. The groove 12 in the upper carrier element 1 prevents a twisting of the clasp.

Fixing elements 3 are connected to the clasps at the desired height, and they hold a fluidic element 4 to be held and fixed, for example a chromatography column, in the desired position. As represented in FIG. 1, a fluidic element can also be fixed by two or more fixing elements 3.

FIG. 3 shows a specific embodiment example of a fixing element 3 for the fixing system represented in FIG. 1. The fixing element 3 consists of a first part 31, two pad elements 32, and a second part 33. The first part 31 can be fixed by fixing means comprising two arms 35 with a turning movement to one of the clasps 2, and, if necessary, it can be shifted in the vertical direction also against frictional locking.

The second part 33 consists of a springy ring 33a, which is connected via four bridges 33c to a central area 33b. In the annular space between the bridges 33c, two arms 31a of a U-shaped area of the first part 31 engage. To connect the first part and the second part 31, 33, the arms of the U-shaped area of the first part 31 present on their external sides notched means 34, which work in cooperation with counter-notched means on the associated internal surfaces of the ring 33a of the second part 33.

By compressing the ring 33a together in the direction of the arrows drawn in the figure (FIG. 3), the ring is enlarged in the direction perpendicular to the former direction, so that the latching fixation is released, and the ring can be removed. In this way, the fluidic element 4 can be inserted into the U-shaped area of the first part 31, and then fixed subsequently by sliding on the second part 33. The notched means 34 and the counter-notched means can be designed here in such a way that it is possible to slide the first part and the second part together into the desired clamping position without having to push the ring 33a of the second part 33 together, while, however, the two parts can be pulled apart only by compression of the ring 33a. This can be achieved, for example, by an appropriate selection of the angle of the latching teeth.

One pad 32 can be connected to the base of the U-shaped area of the first part 31, and to the surface, facing the former area, of the central area of the second part. These pads 32, as a result of their additional spring action, prevent the sliding of the fluidic components, while simultaneously protecting sensitive fluidic elements, such as capillary columns, against damage.

FIG. 4 shows the back view of a fixing element 3 that is attached to a clasp 2 and that fixes a fluidic component 4. In this view, the fixing means for the fixation of the fixing element 3 to the clasp 2 can be seen clearly. The two arms 35 respectively extend from facing external areas of the cross section of the first element 3 in the direction of the respective facing external area substantially parallel to the back side of the first part 31. The separation between the back side of part 31 and the arms 35 is chosen so that the fixing area 2e (FIG. 2) of the clasp 2 between the back side of the part 31 and the arms 35 can be fixed in a clamping way. The force of the frictional locking is preferably chosen so that the part 31 and thus also the entire fixing element 3 can be shifted, still in the clamped state, on the clasp 2. Between the facing lateral surfaces of the arms 35, a separation h is maintained, which makes it possible to insert the clasp 2 or its fixing area 2e, between the two arms 35, or to set the fixing element or at least its first part 31 with the arms 35 on the fixing area 2e of the clasp 2, if the first part 31 is turned in such a way that the two arms 35 run parallel to the fixing area 2e. After setting the part 31 on the fixing area 2e of the clasp 2, the part 31 (or the entire fixing element) can be turned by approximately 90°, so that the clamping position represented in FIG. 4 is achieved.

Using the fixing system that has been described up to now and that is represented in the drawing, the fixing elements 3 can be arranged in any desired way in a two-dimensional plane. As a result, it is also possible to respectively fix one or more fluidic components of different length in the most advantageous position.

For even more complicated applications, it is also possible to use a three-dimensional arrangement in several planes. For this purpose, the clasps 2 can be used in several embodiments with different construction depth, i.e., different clasps 2 present different separations of the fixing areas 2e from the carrier elements 1.

The fixing system according to the invention thus allows the arrangement and the fixing of fluidic components 4 in practically any desired position. As a result of the flexible arrangement of the fixing elements, fluidic components of different size, for example, columns of different lengths, can be fastened reliably. At the same time, the flexible arrangement allows a better utilization of the space in a column oven. Therefore, several components can be arranged in the same space, or a smaller column oven can be sufficient for a given number of components.

The fixing means of the fixing elements 3 on the clasps 2, in comparison to a normal snap-on connection, reliably prevent accidental loosening of the connection, because the fixing elements 3 are fixed by the incorporated fluidic components 4 in their given angular position. Therefore, a column oven which is equipped with this fixing system, with incorporated fluidic components 4, can be transported safely. The latching locking and the pads 32 of the fixing elements 3 allow the reliable fixation of fluidic components 4 having different external diameters or external dimensions and cross sections.

1. Fixing system for at least one fluidic component of a chromatography device, particularly for fastening the at least one fluidic component (4) in a column oven, characterized in that,
(a) at least one clasp (2) is provided, on which at least one fixing element (3) is fixed in a detachable way in a desired position within the fixing area (2e) of the clasp (2) by friction locking or positive locking,
(b) where the at least one clasp (2) is fixed by means of one or more carrier elements (1) in a predetermined position, and
(c) where the at least one fixing element (3) is configured for receiving and fastening the at least one fluidic component (4).

2. Fixing system according to claim 1, characterized in that the at least one clasp (2) is arranged vertically.

3. Fixing system according to claim 1, characterized in that several clasps (2) are fixed or can be fixed in a substantially parallel arrangement by means of the one or more carrier elements (1) at one or more predetermined separations.

4. Fixing system according to claim 1 characterized in that the at least one clasp (2) can be fixed with its end areas (2a, 2b) to one carrier element (1), where the two carrier elements (1) run preferably substantially parallel.

5. Fixing system according to claim 4, characterized in that the at least one clasp (2) can be fixed with one of end areas (2a, 2b) to a multitude of predetermined positions on the carrier element (1) in question, preferably by a positive detachable locking.

6. Fixing system according to claim 4, characterized in that the end areas (2a, 2b) of the clasps (2) are held in corresponding bores (11, 13) of one carrier element (1), where the at least one clasp (2) is preferably designed to be elastic and bendable so that it can be detached by bending from its fixed position.

7. Fixing system according to claim 1 characterized in that the at least one fixing element (3) can be shifted within the fixing area (2e) of the at least one clasp (2) against the fastening force of the frictional locking or of a notching positive locking.

8. Fixing element for a fixing system according to claim 1 characterized in that a first part (31) of the fixing element (3) is connected in such a way to a second part (33) of the fixing element (3) that the fluidic components (4) to be held and fixed can be fixed between two clasp areas of the first part (31) and the second part (33) by frictional locking or positive locking.

9. Fixing element according to claim 8, characterized in that the first part (31) or second part (33) presents engagement and fastening means for the detachable connection to the fixing area of a clasp.

10. Fixing element according to claim 9, characterized in that the engagement and fastening means present two arms (31a), which can be brought into engagement by a turning motion of preferably 90° with the fixing areas (2e) of the clasp (2).

11. Fixing element according to claim 10, characterized in that the two arms (31a) respectively extend from facing areas of the first part (31) or the second part (33), toward each other and parallel to each other, and enclose between them a separation (h), which allows, in a radial reception position, the reception of the fixing area (2c) of the clasp (2) between the arms (31a), in order to subsequently bring the arms (31a) into engagement with the fixing area (2c) of the clasp (2) by turning the first part (31) or second part (33) of the fixing element by a predetermined angle about its longitudinal axis.

12. Fixing element according to claim 8 characterized in that the first part (31) presents a U-shaped connection area for the detachable locking to a second part (33).

13. Fixing element according to claim 12, characterized in that the second part (33) presents a central area (33b), which is connected via one or more bridges (33c) to a ring (33a) that surrounds the central area (33b), where the ring (33a) is configured to be elastically deformable at least in the radial direction in such a way that, in the deformed state, the connection between the first part (31) and the second part (33) is detachable.

14. Fixing element according to claim 13, characterized in that, in the connected state of the first part (31) and the second part (33), the arms (31a) of the U-shaped connection area of the first part (31) engage in the annular space between the central area (33b) and the ring (33a) of the second part (33), where the connection of the first part (31) and the second part (33) is achieved by frictional locking or positive locking, particularly by a positive locking achieved with a notched means (34), between the internal wall of the ring of the second part (33) and the external wall of the arm (31a) of the U-shaped connection area of the first part (31).

15. Fixing element according to claim 14, characterized in that, in engagement areas of the external walls of the arms (31a) of the U-shaped connection area of the first part (31), first notched means (34) are provided, which work in cooperation with the second notched means, which are provided in the engagement areas on the internal wall of the ring of the second part, for the notching connection of the first part (31) and the second part (33).

16. Fixing element according to claim 13, characterized in that the fluidic component (4) can be fixed in a clamping and preferably elastically springy way between the base of the U-shaped connection area of the first part (31) and the central area (33b) of the second part (33), if the first part (31) and the second part (33) are brought into sufficiently tight engagement in the axial direction.

17. Fixing element according to claim 16, characterized in that, on at least one of the surfaces of the first part (31) or the second part (33), a flexibly deformable pad (32) is provided for clamping the fluidic component (4).
